(19) United States
(12) Patent Application Publication
(10) Pub. No.: US 2026/0228487 A1
(43) Pub. Date: Aug. 6, 2026

(54) NEURAL NETWORKS WITH LINEAR RECURRENCE AND FEEDFORWARD UNITS

(71) Applicant: GDM Holding LLC, Mountain View, CA (US)

(72) Inventors: Soham De, London (GB); Antonio Orvieto, London (GB); Samuel Laurence Smith, Oxford (GB); Albert Gu, Pittsburgh, PA (US); Anushan Kalinga Fernando, London (GB); Caglar Gulcehre, Lausanne (CH); Razvan Pascanu, Letchworth Garden City (GB)

(21) Appl. No.: 19/151,220

(22) PCT Filed: Jan. 25, 2024
(86) PCT No.: PCT/EP2024/051753

§ 371 Date: Jul. 25, 2025

Related U.S. Application Data
(60) Provisional application No. 63/441,434, filed on Jan. 26, 2023.

(51) Int. Cl. G06N 3/044; G06N 3/0499

(52) U.S. Cl. CPC G06N 3/044; G06N 3/0499

(57) ABSTRACT

Methods, systems, and apparatus, including computer programs encoded on a computer storage medium, for processing sequence data using neural networks with linear recurrence and feedforward units. In one aspect, a system for performing a machine learning task on a network input to generate a network output is provided. The system includes one or more computers and one or more storage devices storing instructions that, when executed by the one or more computers, cause the one or more computers to implement a neural network configured to perform the machine learning task. The neural network includes a number of layer blocks each including: (i) a linear recurrent layer, and (ii) one or more feedforward layers. Each layer block is configured to perform operations including: receiving an input sequence for the layer block; and generating an output sequence for the layer block.

### CROSS-REFERENCE TO RELATED APPLICATION

This application claims priority to U.S. Provisional Application No. 63/441,434, filed on Jan. 26, 2023. The disclosure of the prior application is considered part of and is incorporated by reference in the disclosure of this application.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations that generates network outputs in response to received network inputs using a neural network.

Examples of the neural network described in this specification employ linear recurrence and feedforward units for processing, generating, or otherwise manipulating sequence data, e.g., long sequence data, to perform machine learning tasks. Particularly, this specification introduces a linear recurrent layer, dubbed the “Linear Recurrent Unit” (or LRU), that can be effectively and efficiently used as the primary neural network layers for deep sequence models—the neural network described herein being one such model. In the described examples, the neural network includes a sequence of layer blocks, e.g., in a residual configuration, that each include: (i) a linear recurrent layer (or LRU), and (ii) one or more feedforward layers. The linear recurrent layer implements linear recurrence for a layer block. The feedforward layer(s) implement nonlinearities for the layer block, e.g., using multilayer perceptrons (MLPs) and/or gated linear units (GLUs). The feedforward layer(s) are neural network layers which do not implement recurrence, e.g., such that their outputs at corresponding positions (or timesteps) do not depend upon their outputs at any previous positions (or timesteps). In other words, the feedforward layer(s) are layers of the neural network that pass information unidirectionally, from one layer to the next, without any feedback. A brief review of feedforward neural networks is provided by Sazli, Murat H. “A brief review of feed-forward neural networks.” Communications Faculty of Sciences University of Ankara Series A2-A3 Physical Sciences and Engineering 50.01 (2006).

By shunting nonlinearities to the feedforward layer(s), i.e., refraining from using nonlinear recurrence, the neural network can achieve performance on machine learning tasks that has been unreachable by currently available neural network architectures, e.g., existing recurrent neural network (RNN) architectures, especially on tasks involving long-range reasoning. For example, the neural network can implement deep models that include a large sequence (or stack) of layer blocks, e.g., 2 or more layer blocks, 5 or more layer blocks, 10 or more layers blocks, 20 or more layer blocks, 50 or more layer blocks, 100 or more layer blocks, 200 or more layer blocks, 500 or more layer blocks, 1000 or more layer blocks, to efficiently process long-range sequences. A long-range sequence generally refers to a sequence of 2000 or more data elements, e.g., 4000 or more data elements, 8000 or more data elements, 16000 or more data elements, 32000 or more data elements, 64000 or more data elements, 128000 or more data elements.

This specification also provides several modifications to the linear recurrent layer (LRU), e.g., diagonalization, stable exponential parameterization, normalization, and parallelization, that can improve stability of the neural network during training, e.g., by mitigating vanishing and exploding gradients, as well as increase speed and accuracy of the neural network considerably at inference time.

These and other aspects of the subject matter described in this specification are summarized below.

In a first aspect, a system for performing a machine learning task on a network input to generate a network output is provided. The system includes one or more computers and one or more storage devices storing instructions that, when executed by the one or more computers, cause the one or more computers to implement: a neural network configured to perform the machine learning task, the neural network including a number of layer blocks each including: (i) a linear recurrent layer, and (ii) one or more feedforward layers, where each layer block is configured to perform operations including: receiving an input sequence for the layer block that includes a respective input at each of a number of input positions; and generating an output sequence for the layer block that includes a respective output at each of a number of output positions, the generating including: processing the input sequence, using the linear recurrent layer of the layer block, to generate an initial output sequence that includes a respective initial output at each of the number of input positions; and processing the initial output sequence, using the one or more feedforward layers of the layer block, to generate the output sequence.

In some implementations of the system, the number of layer blocks are organized in a sequence, and for each layer block that is not a first layer block in the sequence of layer blocks, the input sequence for the layer block is the output sequence of a preceding layer block in the sequence of layer blocks.

In some implementations of the system, the network input is the input sequence for the first layer block in the sequence of layer blocks.

In some implementations of the system, the neural network further includes an encoder configured to perform operations including: receiving the network input; and processing the network input to generate the input sequence for the first layer block in the sequence of layer blocks.

In some implementations of the system, the encoder is a linear encoder.

In some implementations of the system, the neural network further includes one or more output layers configured to perform operations including: receiving the output sequence of a last layer block in the sequence of layer blocks; and processing the output sequence of the last layer block to generate the network output.

In some implementations of the system, the one or more output layers are linear layers.

In some implementations of the system, the linear recurrent layer of each layer block is parametrized by a number of matrices, and where processing the input sequence, using the linear recurrent layer of the layer block, to generate the initial output sequence includes, for each input position: obtaining a current hidden state (in the case of the first input position, the current hidden state may be initialized in any way, e.g., as a default value such as zero); computing a first matrix-vector product between: (i) a first matrix of the linear recurrent layer, and (ii) the current hidden state; receiving the input for the input position; computing a second matrix-vector product between: (i) a second matrix of the linear recurrent layer, and (ii) the input for the input position; and summing the first and second matrix-vector products to generate an updated hidden state.

In some implementations of the system, the first matrix of each linear recurrent layer is a diagonal matrix parametrized by a number of eigenvalues.

In some implementations of the system, each eigenvalue has a magnitude less than one.

In some implementations of the system, the eigenvalues include complex eigenvalues.

In some implementations of the system, each complex eigenvalue is represented as an exponential function parametrized by a complex argument.

In some implementations of the system, the linear recurrent layer of each layer block is further parametrized by a normalization parameter, and where processing the input sequence, using the linear recurrent layer of the layer block, to generate the initial output sequence further includes, for each input position: computing an element-wise product between: (i) the normalization parameter of the linear recurrent layer, and (ii) the second matrix-vector product, and where summing the first and second matrix-vector products to generate the updated hidden state includes: summing the first matrix-vector product and the element-wise product to generate the updated hidden state.

In some implementations of the system, processing the input sequence, using the linear recurrent layer of the layer block, to generate the initial output sequence further includes, for each input position: computing a third matrix-vector product between: (i) a third matrix of the linear recurrent layer, and (ii) the updated hidden state; computing a fourth matrix-vector product between: (i) a fourth matrix of the linear recurrent layer, and (ii) the input for the input position; and summing the third and fourth matrix-vector products to generate the initial output for the input position.

In some implementations of the system, the neural network has been trained on a number of training examples to perform the machine learning task, each training example including: (i) a respective training network input, and (ii) a corresponding target network output, and where the training included: processing the training network input of each training example, using the neural network, to generate a training network output that is an estimate of the corresponding target network output for the training example; determining gradients of an objective function that depends on the training and target network outputs of each training example (e.g., the objective function can include a respective similarity measure between the training and target network outputs of each training example); and using the gradients of the objective function to update the respective parameters of one or more of the linear recurrent layers.

In some implementations of the system, the training further included, for each linear recurrent layer that was updated: initializing the complex argument of each complex eigenvalue parametrizing the linear recurrent layer near zero.

In some implementations of the system, the training further included, for each linear recurrent layer that was updated: initializing the normalization parameter parametrizing the linear recurrent layer using the eigenvalues of the first matrix of the linear recurrent layer.

In some implementations of the system, for each layer block, the number of input positions for the layer block is equal to the number of output positions for the layer block.

In some implementations of the system, the one or more feedforward layers of each layer block include: (i) a multilayer perceptron, (ii) a gated linear unit, or (iii) both.

In some implementations of the system, the network input is a long-range sequence.

In some implementations of the system, the network input includes two thousand or more data elements.

In some implementations of the system, the data elements are tokens.

In some implementations of the system, the linear recurrent layer of each layer block is configured to perform a parallel scan on the input sequence to generate the initial output sequence.

In some implementations of the system, the parallel scan is a work-efficient parallel scan.

In some implementations of the system, the layer blocks are implemented by multiple processors operating in parallel.

In some implementations of the system, the network input includes data to be compressed, and the network output includes a compressed version of the data.

In some implementations of the system, the network input includes audio data characterizing an audio waveform, and the network output includes a spectrogram of the audio waveform.

In some implementations of the system, the network input includes: (i) intensity values for pixels of an input image, or (ii) an encoded representation of the intensity values for the pixels of the input image, and the network output is: (i) an image classification output classifying the input image into one of multiple object categories, (ii) an object detection output specifying coordinates of one or more bounding boxes in the input image that are predicted to encompass objects, or (iii) a segmentation output classifying each pixel in the input image into one of multiple categories.

In some implementations of the system, the machine learning task is an agent control task for an agent in an environment, the network input is a sequence of observations characterizing states of the environment, and the network output defines an action to be performed by the agent in response to the most recent observation in the sequence.

In some implementations of the system, the machine learning task is a health prediction task, the network input includes data derived from an electronic health record of a patient, and the network output is a prediction output defining: (i) a predicted treatment that should be prescribed to the patient, (ii) a likelihood that an adverse health event will occur to the patient, or (iii) a predicted diagnosis for the patient.

In a second aspect, one or more computer storage media are provided. The one or more computer storage media store instructions that, when executed by one or more computers, cause the one or more computers to implement the neural network of any of the abovementioned systems.

In a third aspect, a method performed by one or more computers is provided. The method includes: receiving a network input; and processing the network input, using the neural network of any of the abovementioned systems, to generate a network output for the network input.

The subject matter described in this specification can be implemented in particular embodiments so as to realize one or more of the following advantages.

Transformers are generally efficient and scalable but can become prohibitively expensive to train and deploy on long sequence data. This is because the standard self-attention mechanism of Transformers scales quadratically with respect to sequence length L, involving O(L²) time and space during inference. In contrast, recurrent neural networks (RNNs) scale linearly O(L) with sequence length at inference and are typically faster than Transformers even for modest sequence lengths. That being said, traditional RNNs and their gated variants can be difficult (or infeasible) to train in practice. Particularly, traditional RNNs that implement nonlinear recurrence, e.g., using tanh or sigmoid activation functions, suffer from the vanishing gradient problem, which occurs when gradients of recurrent weights become vanishingly small as they are backpropagated through an RNN. The vanishing gradient problem generally inhibits RNNs from learning long-range dependencies in sequential data. As a result, RNNs have, at present, been supplanted by other models.

This specification describes a linear recurrent layer, dubbed the “Linear Recurrent Unit” (or LRU), that, in implementations described herein, overcomes the vanishing gradient problem, is highly parallelizable (e.g., accordingly to a work-efficient parallel scan), is capable of learning long-range interactions in the data, and can be utilized for deep, performant, and efficient neural network models. For example, the neural network architecture described in this specification can perform machine learning tasks on sequential data involving 16000 or more interacting tokens, e.g., machine learning tasks in the Long-Range Arena (LRA) such as PathFinder and PathX. Performance of the neural network for select tasks in the LRA are provided herein, showing marked improvement over conventional RNN architectures.

Examples of the neural network described herein provide a general framework for theoretically principled and computationally efficient long-ranged reasoning using stacks of linear recurrent layers interleaved with feedforward layers. The neural network architectures described herein can be applied to numerous machine learning tasks such as language modelling, natural language processing (e.g., text classification), machine translation, reading comprehension, question answering, video processing, and computer vision, among other domains.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a block diagram of an example system configured to perform a machine learning task using a neural network.

FIG. 1B is a block diagram of an example residual layer block.

FIG. 1C is a schematic diagram of an example linear recurrent layer implementing linear recurrence.

FIG. 2A is a flow diagram of an example process for processing a network input to generate a network output using a neural network.

FIG. 2B is a flow diagram of an example process for processing an input sequence to generate an output sequence using a residual layer block.

FIG. 2C is a flow diagram of an example process for processing an input sequence to generate an initial output sequence using a linear recurrent layer.

FIG. 3A is a block diagram of an example training engine configured to train a neural network to perform a machine learning task.

FIG. 3B is a flow diagram of an example process for training a neural network to perform a machine learning task.

FIGS. 4A-4C show eigenvalues of a transition matrix for a linear recurrent layer following a Glorot initialization.

FIG. 4D show eigenvalues of a diagonal transition matrix for a linear recurrent layer following an equivalent spectral initialization.

FIGS. 5A-5C are experimental plots showing training loss, training accuracy, and test accuracy versus training iterations of a neural network trained to perform the PathXtask.

FIG. 6 shows an example JAX implementation of a linear recurrent layer.

Like reference numbers and designations in the various drawings indicate like elements.

### DETAILED DESCRIPTION

Recurrent neural networks (RNNs) have played a prominent role since the inception of deep machine learning and are a natural choice when modelling sequential data. However, while these neural networks have strong theoretical properties, such as Turing completeness, they can be hard to train in practice. In particular, RNNs suffer from the vanishing and exploding gradient problem, making it difficult for these models to learn long-range dependencies in the data. Several techniques have been developed that attempt to mitigate this issue, including orthogonal RNNs, unitary RNNs, and gating mechanisms, e.g., long short-term memory (LSTM) and gated recurrent units (GRUs). Nonetheless, these models are still slow to optimize due to the sequential nature of their computation, introducing numerous difficulties when scaled.

In recent years, Transformers have gained increasing prominence for sequence modelling tasks, achieving success in a wide range of applications, e.g., in large language models (LLMs). Compared to traditional (nonlinear) recurrent layers, attention layers are typically easier to scale and parallelize during training, and they do not suffer from the vanishing gradient problem. An issue with attention layers, however, is that their computational and memory costs scale quadratically O(L²) with the sequence length L. Hence, Transformers can be expensive to deploy on long-range sequences. RNNs, which scale linearly O(L) with the sequence length, are typically faster than Transformers at inference time, even for modest sequence lengths.

Motivated by these problems, this specification introduces a linear recurrent layer, dubbed the “Linear Recurrent Unit” (or LRU), that, in implementations described below, overcomes the vanishing and exploding gradient problem, can be utilized for deep, performant, and efficient neural network models, and is capable of learning long-range interactions in sequence data. Neural networks utilizing the linear recurrent layers described herein can provide memory savings, lower latency, and higher throughput in memory-constrained and other systems where computational resources are scarce, e.g., smartphones, smartwatches, personal computers (PCs), laptops, tablets, wearable devices, edge computing devices, minicomputers, and the like. For example, since their computational and memory costs scale as O(L), they can be implemented in systems where other neural network models, e.g., Transformers, would be impractical or infeasible.

Examples of neural networks utilizing linear recurrent layers demonstrate a number of advantages and theoretical insights related to sequence data processing, as well as RNNs as whole, including, but not limited to one or more of:

Linear Recurrences. Removing nonlinearities in recurrence, i.e., using linear recurrence, provides a substantial improvement in inference accuracy. This specification demonstrates that stacking linear recurrent layers interleaved with feedforward layers can model complex nonlinear sequence-to-sequence maps without involving nonlinearities in recurrence. In general, dropping nonlinearity in recurrence does not harm expressivity of a RNN and leads to several advantages, e.g., the ability to directly control how quickly gradients vanish or explode, the ability to parallelize training and inference, among other features.

Complex Diagonal Recurrent Matrices. Dense linear recurrent layers, e.g., linear recurrent layers with deep connection, can be re-parameterized to a complex diagonal form. The complex diagonal form reduces the number of parameters of a linear recurrent layer, while also speeding up training and inference, e.g., since computing powers of diagonal matrices is computationally cheap compared to dense matrices. This is achieved without affecting the expressivity of the neural network or the features at initialization. Additionally, diagonally parameterized linear recurrent layers allow for a highly parallelizable unrolling of the recurrence, e.g., using work-efficient parallel scans, to substantially improve training and inference speeds.

Stable Exponential Parameterization. Using an exponential parameterization for the diagonal transition matrix has a number of benefits, e.g., enabling stability during training, which in turn allows modification of the initialization distribution, e.g., to facilitate long-range reasoning and improve performance.

Normalization. Normalizing the hidden activations on the forward pass can further improve the performance of the neural network on tasks involving long-range dependencies.

These and other features related to the systems and methods disclosed in this specification are described in more detail below.

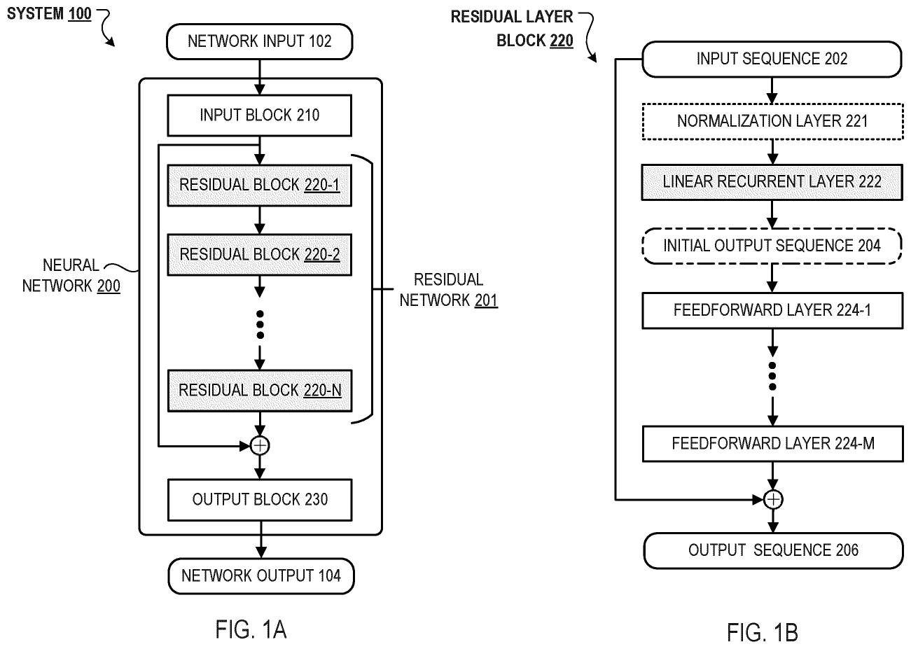

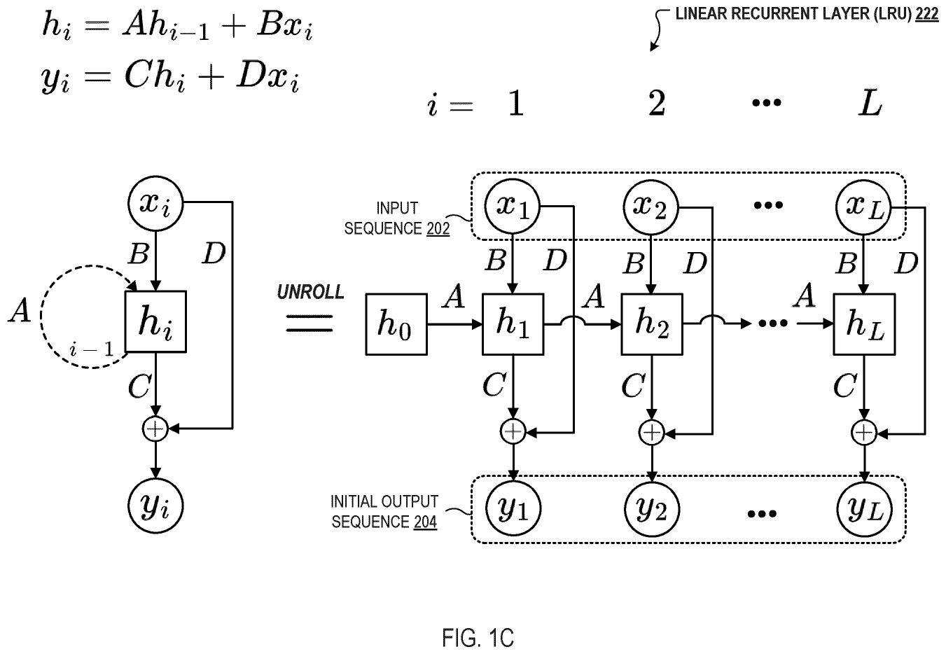

FIG. 1A is a block diagram of an example system 100 configured to perform a machine learning task using a neural network 200. The system 100 is an example of a system implemented as computer programs on one or more computers in one or more locations in which the systems, components, and techniques described below are implemented.

At a high-level, the system 100 is configured to: receive a network input (X) 102; and process the network input 102, using the neural network 200, to generate a network output (Ŷ=f_{θ}(X)) 104. Here, f_{θ} is a function representing the parametric model of the neural network 200, parameterized by a set of network parameters (θ). In general, the network parameters (θ) include the respective (learnable) parameters of each neural network layer in the neural network 200. The learnable parameters relevant to a linear recurrent layer 222 are described in detail herein.

The neural network 200 is configured to perform the machine learning task on the network input 102 to generate the network output 104. The machine learning task can be any machine learning task that: (i) operates on a network input 102 that is an input sequence, (ii) generates a network output 104 that is an output sequence, or (iii) both. For convenience, examples of machine learning tasks that the system 100 can perform using the neural network 200 are described at the end of this specification.

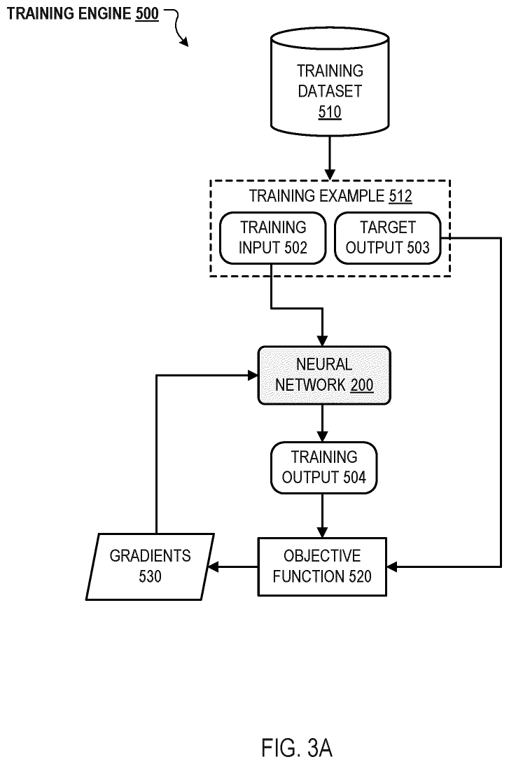

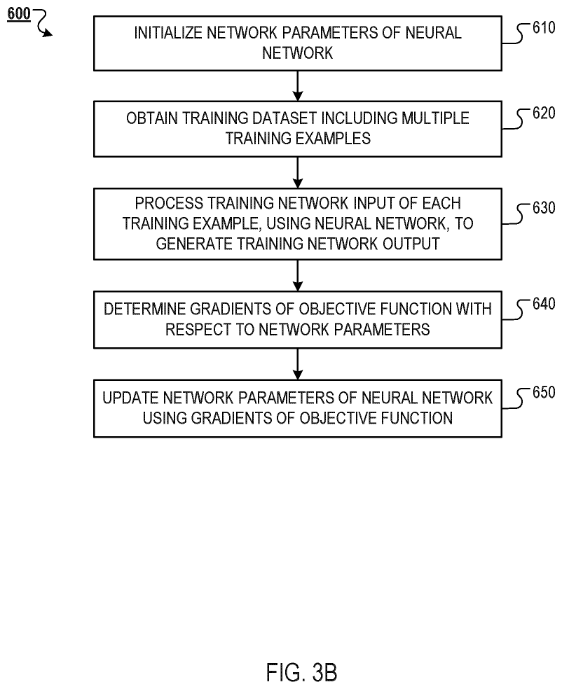

Of particular note, the neural network 200 can efficiently process network inputs 102 that include long-range sequences. A long-range sequence generally refers to a sequence of 2000 or more data elements, e.g., 4000 or more data elements, 8000 or more data elements, 16000 or more data elements, 32000 or more data elements, 64000 or more data elements, 128000 or more data elements. For example, the neural network 200 can perform machine learning tasks on network inputs 102 including a sequence of 16000 or more interacting tokens, e.g., machine learning tasks in the Long-Range Arena (LRA) such as PathFinder and PathX. Performance of the neural network 200 for select machine learning tasks in the LRA are described with reference to FIGS. 3A-5C. Here, various modifications and re-parametrizations of the linear recurrent layer 222 are described, step-by-step, for improving inference accuracy and other performance metrics of the neural network 200 on long-range tasks. Details of particular tasks in the LRA, such as training and test datasets, are provided by Yi Tay, et al., “Long-Range Arena: A Benchmark for Efficient Transformers.” arXiv preprint arXiv:2011.04006 (2020).

Note, in implementations when the network input 102 is an input sequence, the neural network 200 can receive all the inputs in the network input 102 simultaneously, or each input in the network input 102 sequentially, e.g., in a streaming fashion. Likewise, in implementations when the network output 104 is an output sequence, the neural network 200 can generate all the outputs in the network output 104 simultaneously, or each output in the network output 104 sequentially. As one example, in some implementations, the neural network 200 can be utilized for batch (or offline) inference. In these cases, the neural network 200 may receive and process each input in the network input 102 simultaneously, and thereafter generate each output in the network output 104 simultaneously. As another example, in some implementations, the neural network 200 can be utilized for online inference. In these cases, the network input 102 may be a data stream that includes a respective input at each of multiple timesteps and the network output 104 may include a respective output for each timestep. Then, at each timestep, the neural network 200 can receive the input in the network input 102 for the timestep and process the input to generate the respective output in the network output 104 for the timestep.

Referring to FIG. 1A, the neural network 200 includes a sequence (or stack) of layer blocks that each include one or more neural network layers. More particularly, the sequence of layer blocks includes: an input layer block 210, multiple intermediate layer blocks 220-1 through 220-N, and an output layer block 230. In this example, a skip connection, e.g., an identity skip connection, places the intermediate layer blocks 220 in a residual configuration, forming a residual network 201 of residual layer blocks 220-1 through 220-N. Generally, a residual configuration enables the neural network 200 to implement deep models, e.g., having tens, hundreds, thousands, or tens of thousands of neural network layers, that are easier to train and approach better accuracy with increasing numbers of layers. For example, the residual network 201 can include 2 or more layer blocks, 5 or more layer blocks, 10 or more layers blocks, 20 or more layer blocks, 50 or more layer blocks, 100 or more layer blocks, 200 or more layer blocks, 500 or more layer blocks, 1000 or more layer blocks, and so on. That being said, in some implementations, the skip connection may be absent, such that the output layer block 230 does not receive the output of the input layer block 210.

The input layer block 210 is configured to: receive the network input 102; and process the network input 102 to generate an input sequence 202 for a first residual layer block 220-1 in the residual network 201. In some implementations, the input layer block 210 includes one or more linear neural network layers. In general, a linear layer is a layer of the neural network 200 for which each of multiple values of the layer's output is a linear function of multiple values of the layer's input. In some implementations, the input layer block 210 is an encoder, e.g., a linear encoder. The encoder 210 can encode the network input 102 into a sequence of embeddings representing the network input 102. As one example, if the network input 102 is a sequence of data elements, e.g., a sequence of tokens, the encoder 210 can encode each data element in the sequence into a respective embedding of the data element. In other implementations, e.g., when the network input 102 is a pre-embedded sequence, the network input 102 can be directly processed by the first residual layer block 220-1 in the residual network 201, i.e., the input layer block 210 can be omitted or bypassed. Various different types of network inputs 102 that can be processed by the neural network 200 are described at the end of this specification.

The first residual layer block 220-1 in the residual network 201 is configured to receive an input sequence 202, e.g., one generated as output by the input layer block 210 or the network input 102 itself, and process the input sequence 202 to generate an output sequence 206. Each residual layer block 220 in the residual network 201 after the first residual layer block 220-1 is configured to: receive a respective input sequence 202, i.e., one generated as output by a preceding residual layer block 220 in the residual network 201; and process the respective input sequence 202 to generate, as output, a respective output sequence 206. Operations of an individual residual layer block 220 are described in more detail below with reference to FIG. 1B.

The output layer block 230 is configured to: receive an output sequence 206-N generated by a last residual layer block 220-N in the residual network 201; and process the output sequence 206-N to generate the network output 104. In this example, the output sequence 206-N of the last residual layer block 220-N is also summed with the output of the input layer block 210 due to the skip connection. In some implementations, the output layer block 230 includes one or more linear neural network layers. For example, the output layer block 230 can generate a classification output as the network output 104 by contracting over the output sequence of the last residual layer block 220-N. In some implementations, the output layer block 230 is a decoder, e.g., a linear decoder. The decoder 230 can decode the output sequence of the last residual layer block 220-N into the network output 104. As one example, if the output sequence of the last residual layer block 220-N is a sequence of embeddings of data elements, e.g., a sequence of embeddings of tokens, the decoder 230 can decode each embedding in the sequence into a respective data element. Various different types of network outputs 104 that can be generated by the neural network 200 are described at the end of this specification.

In some implementations, the neural network 200 does not include any attention layers (e.g., self-attention layers). In other words, the input layer block 210, each residual layer block 220, and the output layer block 230 do not include any attention layers. For example, in some implementations, none of the layer blocks 210, 220, and 230 in the neural network 200 are Transformer layer blocks that implement multi-head attention mechanisms. As mentioned above, attention layers scale as O(L²) and can be a bottleneck on long sequences. The neural network 200 can utilize linear recurrence and feedforward units without attention mechanisms to process long sequences, thereby speeding up computations and reducing memory costs. Further details of the multi-head attention mechanism implemented by Transformer models is provided by Vaswani, Ashish, et al. “Attention is all you need,” Advances in neural information processing systems 30 (2017).

The system 100 can be implemented in any appropriate location, e.g., on a user device (e.g., a mobile device), or on one or more computers in a data center, etc. The modularity of the system 100 allows multiple devices to implement individual components of the system 100 separately from one another. For example, individual layer blocks of the neural network 200 can be executed on different devices and can transmit their outputs and/or inputs to one another (e.g., via telecommunications). Users can interact with the system 100, e.g., by providing queries to the system 100 by way of an interface, e.g., a graphical user interface, or an application programming interface (API). In particular, a user can provide a query that includes: (i) a request to generate a network output 104 for a network input 102, and (ii) the network input 102. In response to receiving the query, the system 100 can process the network input 102, using the neural network 200, to generate the network output 104 responsive to the request and thereafter provide the network output 104 to the user, e.g., for display on a user device of the user, or for storage in a data storage device. In some cases, the system 100 can transmit the network output 104 to a user device of the user, e.g., by way of a data communication network (e.g., the internet).

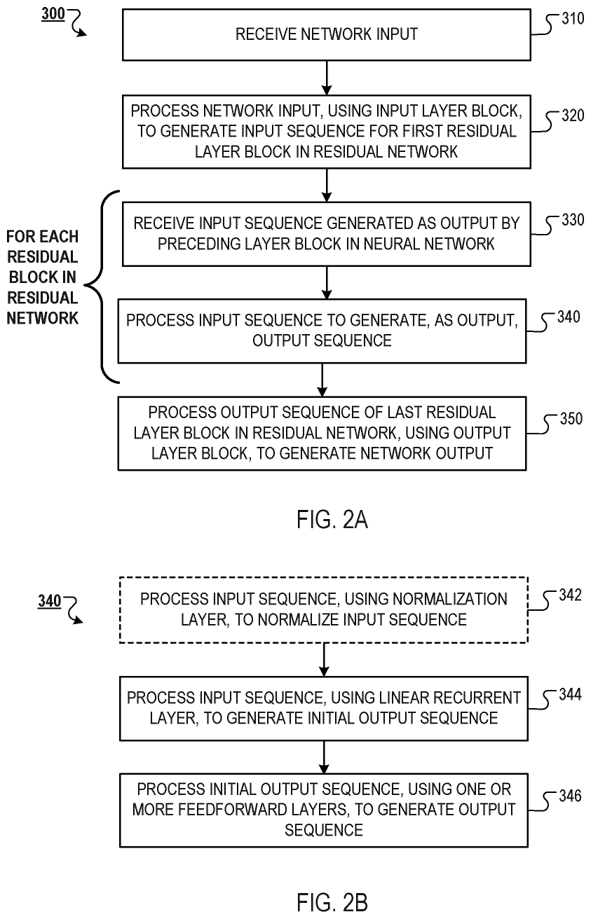

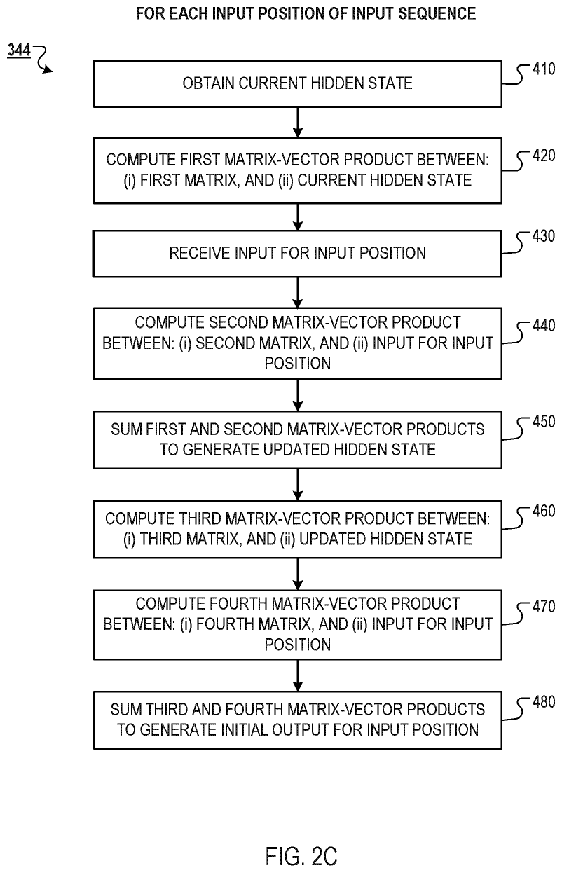

FIG. 2A is a flow diagram of an example process 300 for processing a network input 102 to generate a network output 104 using the neural network 200. For convenience, the process 300 will be described as being performed by a system of one or more computers located in one or more locations. For example, a system, e.g., the system 100 of FIG. 1A, appropriately programmed in accordance with this specification, can perform the process 300 by implementing the neural network 200.

The neural network 200 receives the network input 102 (310).

In some implementations, network input 102 is a long-range sequence. For example, the network input 102 can be a long-range sequence that includes two thousand or more data elements. In some implementations, the data elements are tokens.

The neural network 200 processes the network input 102, using the input layer block 210, to generate an input sequence 202 for the first residual layer block 220-1 in the residual network 201 (320).

In some implementations, the input layer block 210 includes one or more linear neural network layers. In some implementations, the input layer block 210 is an encoder, e.g., a linear encoder.

For each residual layer block 220-1 through 220-N in the residual network 201:

The residual layer block 220 receives a respective input sequence 202 generated as output by a preceding layer block in the neural network 200 (330).

The residual layer block 220 processes the respective input sequence 202 to generate, as output, a respective output sequence 206 (340).

The neural network 200 processes the output sequence 206 of the last residual layer block 220-N in the residual network 201, using the output layer block 230, to generate the network output 104 (350).

In some implementations, the output layer block 230 includes one or more linear neural network layers. In some implementations, the output layer block 230 is a decoder, e.g., a linear decoder.

FIG. 1B is a block diagram of an example residual layer block 220. The residual layer block 220 includes an (optional) normalization layer 221, a linear recurrent layer 222, and one or more feedforward layers 224-1 through 224-M. The residual layer block 220 is configured to: receive an input sequence 202; and process the input sequence 202 to generate, as output, an output sequence 206. In more detail, the residual layer block 220 processes the input sequence 202, using the normalization layer 221, to normalize the input sequence 202. The normalization layer 221 can implement batch normalization (BatchNorm), layer normalization (LayerNorm), or another normalization scheme, which generally improves stability of the residual layer block 220. The residual layer block 220 then processes the input sequence 202, using the linear recurrent layer 222, to generate an initial output sequence 204. The residual layer block 220 then processes the initial output sequence 204, using the feedforward layer(s) 224, to generate the output sequence 206.

The input sequence x=(x₁, x₂, . . . , x_{L}) is of length L and includes a respective input (xᵢ) at each of multiple input positions (i). Each input of the input sequence 202 is generally a Hᵢₙ-dimensional vector. In implementations involving a normalization layer 221, the input sequence 202 may also be normalized x→\hat{x}. For example, in the case of batch normalization, the inputs are normalized over mini batches to have fixed means and variances, while for layer normalization, all inputs are normalized together.

The initial output sequence y=(y₁, y₂, . . . , y_{L}) is also of length L and includes a respective initial output (yᵢ) at each of the input positions (i). Each initial output of the initial output sequence 204 is generally a Hₒᵤₜ-dimensional vector. The initial outputs can have the same (Hₒᵤₜ=Hᵢₙ) or different (Hₒᵤₜ≠Hᵢₙ) dimension as the inputs. The initial output sequence 204 is generated by the linear recurrent layer 222 by implementing linear recurrence on the input sequence 202, e.g., using a parallel scan, which is described in more detail below with reference to FIG. 1C.

The output sequence y=(ŷ₁, ŷ₂, . . . , ŷₗ) is of length l and includes a respective output (ŷⱼ) at each of multiple output positions (j). Each output is generally a Dₒᵤₜ-dimensional vector. The outputs can have the same (Hₒᵤₜ=Dₒᵤₜ) or different dimension (Hₒᵤₜ#Dₒᵤₜ) as the initial outputs. Moreover, the output sequence 206 can have the same (l=L) or different (l≠L) length as the initial output sequence 204. In the example of FIG. 1B, the residual layer block 220 includes a skip connection, e.g., an identity skip connection, that sums the input sequence 202 with the output of the feedforward layer(s) 224 to generate the output sequence 206. In these cases, the input 202 and output 206 sequences generally have the same length and include vectors of the same dimension. The feedforward layer(s) 224 implement (unidirectional) nonlinearities on the initial output sequence 204, e.g., using nonlinear activation functions such as tanh and sigmoid activation functions. For example, in some implementations, the feedforward layer(s) 224 can include: (i) a multilayer perceptron (MLP), (ii) a gated linear unit (GLU), or (iii) both.

Note, in implementations when the network input 102 is a data stream, e.g., for online inference, each input position (i) for the input 202 and initial output 204 sequences can correspond to a respective timestep (or timestamp) in the network input 102. The residual layer block 220 can then generate each output (fj) in the output sequence 206 at the respective timestep sequentially. The residual layer block 220 can then forward the output at the timestep to the next layer block in the neural network 200 for further processing. In these cases, the length of the sequences may, effectively, approach L=l→∞, or a very large number of elements.

FIG. 2B is a flow diagram of an example process 340 for processing an input sequence 202 to generate an output sequence 206 using a residual layer block 220.

The input sequence 202 includes a respective input at each of multiple input positions. The output sequence 206 includes a respective output at each of multiple output positions. In some implementations, the number of input positions is equal to the number of output positions.

In some implementations, the residual layer block 220 first processes the input sequence 202, using a normalization layer 221, to normalize the input sequence 202 (342).

The residual layer block 220 then processes the input sequence 202, using a linear recurrent layer 222, to generate an initial output sequence 204 (344). The initial output sequence 204 includes a respective initial output at each of the input positions.

The residual layer block 220 processes the initial output sequence 204, using one or more feedforward layers 224, to generate the output sequence 206 (346).

In some implementations, the feedforward layer(s) 224 include: (i) a multilayer perceptron (MLP), (ii) a gated linear unit (GLU), or (iii) both.

FIG. 1C is a schematic diagram of an example linear recurrent layer 222, or LRU, that implements linear recurrence on an input sequence 202 to generate an initial output sequence 204. Operations of the linear recurrent layer 222, for each input position, are summarized concisely in the following two equations:

$${h}_{i} = A {h}_{i - 1} + B {x}_{i} , \qquad ( 1 )$$

$$and ,$$

$${y}_{i} = C {h}_{i} + D {x}_{i} . \qquad ( 2 )$$

As shown in Eqs. (1) and (2), the linear recurrent layer 222 is parametrized by a set of matrices {A, B, C, D}∈θ. The set of matrices includes: a first matrix A∈ [symbol] ^{N×N} (also referred to as the transition matrix), a second matrix B∈ [symbol] ^{N×H}^{ᵢₙ}, a third matrix C∈ [symbol] ^{H}^{ₒᵤₜ}^{×N}, and a fourth matrix D∈ [symbol] ^{H}^{ₒᵤₜ}^{×H}^{ᵢₙ}. Note, the linear recurrent layer 222 can additionally be parametrized by bias parameters that produce a biasing offset to the hidden states and/or the initial outputs. This amounts to adding a bias vector to Eq. (1) and/or Eq. (2). However, due to the linearity of the recurrence relation, these parameters can be equivalently incorporated into the feedforward layer(s) 224 preceding and/or following the linear recurrent layer 222 (see FIG. 1B).

Starting at an initial hidden state h₀∈ [symbol] ^{N}, for each input position (i), the linear recurrent layer 222 receives the input (xᵢ) for the position and obtains (e.g., retrieves from memory) a current hidden state (hᵢ₋₁). The hidden state is generally an N-dimensional vector that characterizes the information the linear recurrent layer 222 currently holds at a particular position. Note, the initial hidden state (h₀) can be initialized in any way during inference and training, e.g., as a default or random value, a hyperparameter, etc. A common initialization for the initial hidden state is h₀=0 but others may also be chosen, e.g., with h₀≠0.

Referring to Eq. (1), the linear recurrent layer 222 computes a first matrix-vector product between: (i) the first matrix (A), and (ii) the current hidden state (hᵢ₋₁). The linear recurrent layer 222 computes a second matrix-vector product between: (i) the second matrix (B), and (ii) the input (xᵢ) for the input position. The linear recurrent layer 222 then sums the first and second matrix-vector products to generate an updated hidden state (hᵢ).

Referring to Eq. (2), the linear recurrent layer 222 computes a third matrix-vector product between: (i) the third matrix (C), and (ii) the updated hidden state (hᵢ). The linear recurrent layer 222 computes a fourth matrix-vector product between: (i) the fourth matrix (D), and (ii) the input (xᵢ) for the input position. The linear recurrent layer 222 then sums the third and fourth matrix-vector products to generate the initial output (yᵢ) for the input position.

Since the operations described above with reference to Eqs. (1) and (2) are linear, they can be efficiently parallelized by the linear recurrent layer 222 until i=L−1 using parallel scans. This makes the neural network 200 and linear recurrent layer 222 suitable for use in a parallel computing system. This is in contrast to nonlinear RNNs where computation is performed sequentially, thereby hindering parallelization. An example of a parallel scan, e.g., a parallel prefix scan, that the linear recurrent layer 222 can perform on an input sequence 202 to generate an initial output sequence 204 is described in more detail below. Further details related to parallel scans are provided by Eric Martin and Chris Cundy, “Parallelizing Linear Recurrent Neural Nets Over Sequence Length,” arXiv preprint arXiv:1709.04057 (2017), and Jimmy T. H. Smith, Andrew Warrington, and Scott W. Linderman, “Simplified State Space Layers for Sequence Modeling,” arXiv preprint arXiv:2208.04933 (2022).

Nonetheless, as mentioned previously, the linear recurrent layer 222 can also process each input in the input sequence 202 sequentially via the linear recurrence relation in Eqs. (1) and (2), which can be relevant when the neural network 200 processes a network input 102 that is a data stream, e.g., for online inference. In these cases, each input position (i) can correspond to a respective timestep in the network input 102. For example, at each timestep, the linear recurrent layer 222 can receive the input (xᵢ) for the timestep and obtain the current hidden state (hᵢ₋₁), where the hidden state represents the information held by the linear recurrent layer 222 between timesteps. The linear recurrent layer 222 can then process the input at the timestep and the current hidden state, as outlined in Eqs. (1) and (2), to generate the updated hidden state (hᵢ), and the initial output (yᵢ) for the timestep. The linear recurrent layer 222 then repeats this process for each proceeding timestep.

FIG. 2C is a flow diagram of an example process 344 for processing an input sequence 202 to generate an initial output sequence 204 using a linear recurrent layer 222.

The linear recurrent layer 222 is parametrized by a set of matrices {A, B, C, D} including: a first (transition) matrix (A), a second matrix (B), a third matrix (C), and a fourth matrix (D). The input sequence 202 includes a respective input at each of multiple input positions. The initial output sequence 204 includes a respective initial output at each of the input positions.

For each input position:

The linear recurrent layer 222 obtains a current hidden state (410).

The linear recurrent layer 222 computes a first matrix-vector product between: (i) the first matrix, and (ii) the current hidden state.

The linear recurrent layer 222 receives the input for the input position (430).

The linear recurrent layer 222 computes a second matrix-vector product between: (i) the second matrix, and (ii) the input for the input position (440).

The linear recurrent layer 222 sums the first and second matrix-vector products to generate an updated hidden state (450).

The linear recurrent layer 222 computes a third matrix-vector product between: (i) the third matrix, and (ii) the updated hidden state (460).

The linear recurrent layer 222 computes a fourth matrix-vector product between: (i) the fourth matrix, and (ii) the input for the input position (470).

The linear recurrent layer 222 sums the first and second matrix-vector products to generate the initial output for the input position (480).

FIG. 3 is a block diagram of an example training engine 500 configured to train the neural network 200 to perform a machine learning task. The training engine 500 is an example of a system implemented as computer programs on one or more computers in one or more locations in which the systems, components, and techniques described below are implemented.

First, the general procedure for training the neural network 200 on a generic machine learning task is described. Following this, benchmarking results of the neural network 200 trained on various tasks in the Long-Range Arena (LRA) are provided. The benchmarking results are accompanied with step-by-step modifications to the linear recurrent layer 222 parametrization and initialization scheme that improve various performance metrics of the neural network 200 during training and inference. As a pertinent example, it is known that an RNN can be difficult to train in practice due to the vanishing gradient problem, which occurs when gradients of recurrent weights become vanishingly small as they are backpropagated through the RNN. The linear recurrent layer 222 can mitigate (or altogether eliminate) this effect using a (stable) exponential parameterization of the transition matrix.

To begin, the training engine 500 first initializes the network parameters (θ) of the neural network 200, e.g., the parameters of the normalization layers 221, the parameters of the linear recurrent layers 222, the parameters of the feedforward layers 224, and/or the parameters of other neural network layers in the neural network 200. The training engine 500 then obtains a training dataset

$$𝒟 = {\{ ( {X}_{k} , {Y}_{k} ) \}}_{k = 1}^{{N}_{t}}$$

510 related to a machine learning task, e.g., a task in the LRA. The training dataset 510 includes Nₜ training examples (Xₖ, Yₖ) 512. The training dataset 510 can include any appropriate number of training examples 512 for the machine learning task, e.g., 10³ or more training examples, 10⁴ or more training examples, 10⁵ or more training examples, 10⁶ or more training examples, 10⁷ or more training examples, 10⁸ or more training examples, etc. Each training example 512 includes: (i) a respective training network input (Xₖ) 502, and (ii) a corresponding target network output (Yₖ) 503. The training engine 500 then trains the neural network 200 on the training dataset 510 (or one or more batches ( [symbol] ) of training examples 512 in the training dataset 510) to perform the machine learning task. In general, the training engine 500 trains the neural network 200 to produce the target network output 503 in response to its training network input 502. That is, the training engine 500 processes the training network input 502 of each training example 512, using the neural network 200, to generate a training network output Ŷₖ∈f_{θ}(Xₖ) 504 that is an estimate of the target network output 503 for the training example 512.

The training engine 500 then optimizes an objective function [symbol] (Y₁, . . . , Y_{N}_{ₜ}, Ŷ₁, . . . , Ŷ_{N}_{ₜ}) 520 that depends on the training 504 and target 503 network outputs of each training example 512 in the training dataset 510 (or a batch of training examples 512 in the training dataset 510). Particularly, the training engine 500 minimizes (or maximizes) the objective function 520 with respect to the network parameters of the neural network 200, such as

$$θ = arg {min}_{θ} ℒ .$$

Broadly speaking, the training engine 500 generally uses an objective function 520 that encourages each training network output 504 to meet its respective target network output 503, e.g., as measured by some error or similarity metric between the two. In light of this, the objective function 520 can be (or can include) any appropriate objective function for the training dataset 510 and machine learning task the neural network 200 is trained to perform. For example, the objective function 520 can include a mean squared error loss or a mean absolute error loss for a regression task, a binary cross-entropy loss or a Hinge loss for a binary classification task, a categorical cross-entropy loss for a multi-class classification task, a Kullback-Leibler divergence loss for a generative or reinforcement learning task, a MinMax loss for an image segmentation task, etc.

To optimize the objective function 520, the training engine 500 determines gradients 530 of the objective function 520 with respect to the network parameters of the neural network 200, e.g., using backpropagation. The training engine 500 then uses the gradients 530 to update the network parameters of the neural network 200, e.g., the parameters of the normalization layers 221, the parameters of the linear recurrent layers 222, the parameters of the feedforward layers 224, and/or the parameters of neural network layers in the input layer block 210 and/or output layer block 230. For example, the training engine 500 can use a stochastic gradient descent method with a particular learning rate and/or weight decay, such as Implicit updates, Momentum, Adam, RMSProp, AdaGrad, etc., to update the network parameters with the values that optimize the objective function 520. The training engine 500 can perform any appropriate number of training iterations to optimize the objective function 520, e.g., 10³ or more training iterations, 10⁴ or more training iterations, 10⁵ or more training iterations, 10⁶ or more training iterations, 10⁷ or more training iterations, 10⁸ or more training iterations, etc.

After training, the training engine 500 can then evaluate how well the neural network 200 performs the machine learning task using a test dataset, e.g., to benchmark the neural network 200 for inference accuracy.

In this specification, the neural network 200 was benchmarked against the LRA, a set of machine learning tasks designed to test the ability of neural network models to perform long-range sequence modelling. Transformers typically fail on most of these tasks, e.g., having inference accuracies that do not exceed random guessing. Conversely, the neural network(s) 200 described herein generally perform well on these tasks, e.g., having inference accuracies that exceed random guessing.

For each experiment, the neural network 200 included six residual layer blocks 220 each configured according to FIG. 1B. Each residual layer block 220 included: a batch normalization layer 221, a linear recurrent layer 222, a multilayer perceptron (MLP) for the feedforward layer(s) 224, and a residual skip connection. All experiments were repeated three times—the mean and standard error are reported in Tbls. 1 and 2 below. The neural network(s) 200 were trained using the AdamW optimizer. A small learning rate, e.g., of about 10⁻⁷ to 10⁻⁶, and no weight decay was used on the parameters of the linear recurrent layer 222. More details on the experimental setup are provided by Antonio Orvieto, et al., “Resurrecting Recurrent Neural Networks for Long Sequences,” arXiv preprint arXiv:2303.06349 (2023).

In the following, several modifications to the linear recurrent layer 222 are described, step-by-step, that provide progressively improved performance of the neural network 200 on LRA tasks, as well as other tasks involving long-range reasoning. These modifications are summarized as follows: (i) using the linear recurrent layer 222 to implement linear recurrence (as opposed to nonlinear recurrence, as in some known systems), (ii) diagonalizing the transition matrix to speed up training and inference of the linear recurrent layer 222 (without affecting expressivity and initialization distribution), (iii) changing the parameterization and initialization distribution of the linear recurrent layer 222 to enable stability and improve long-range modeling, and (iv) providing a normalization strategy for the hidden activations of the linear recurrent layer 222.

Tbl. 1 shows that removing nonlinearity in an RNN improves inference accuracy on most LRA tasks. Linear recurrent layers 222 are expressive when coupled with nonlinear feedforward layers 224, outperforming tuned nonlinear RNN variants in the same architecture. In general, interleaving linear recurrent layers 222 with nonlinear feedforward layers 224, such as that shown in FIGS. 1A-1C, is sufficient to approximate highly nonlinear systems.

Table 1: The effect of removing nonlinearity from a recurrent layer on inference accuracy. Results are shown from sCIFAR, ListOps, Text, and Retrieval tasks in the Long-Range Arena (LRA). Bold face indicates the best inference accuracy.

TABLE 1
The effect of removing nonlinearity from a recurrent layer
on inference accuracy. Results are shown from sCIFAR, ListOps,
Text, and Retrieval tasks in the Long-Range Arena (LRA).

| Recurrence | sCIFAR | ListOps | Text | Retrieval |
|---|---|---|---|---|
| RNN-ReLU | 69.7 (0.2) | 37.6 (8.0) | 88.0 (0.1) | 88.5 (0.1) |
| RNN-Tanh | 69.9 (0.3) | 43.9 (0.1) | 87.2 (0.1) | 88.9 (0.2) |
| Neural Network 200 | 72.2 (0.2) | 50.4 (0.2) | 89.1 (0.1) | 89.1 (0.1) |

Bold face indicates the best inference accuracy.

Another advantage of linear recurrence is that many properties of linear algebra can be utilized by the linear recurrent layer 222. As shown in FIG. 1C, the recurrence relation of Eq. (1) can be unrolled using the initialization h₀=0, as follows:

$${h}_{i} = {\sum }_{k = 1}^{i} {A}^{k - 1} B {x}_{i - k} . \qquad ( 3 )$$

Exponentiations of the transition matrix (A) are the source of the vanishing (and exploding) gradient issue in RNNs. While in nonlinear RNNs the hidden state hᵢ is projected onto the compact image of the activation function, the hidden state of the linear recurrent layer 222 may potentially vanish or explode exponentially as i increases. This phenomenon can be understood by leveraging an eigenvalue (spectral) analysis. Up to arbitrarily small perturbation in its entries, the transition matrix A is diagonalizable, that is, can be parameterized as A=PAP⁻¹, where P∈ [symbol] ^{N×N} is an invertible matrix and Λ=diag(λ₁, λ₂, . . . , λ_{N})∈ [symbol] ^{N×N} is a diagonal matrix of eigenvalues (λₙ), with n=1, 2 . . . , N. When the transition matrix is symmetric A=A^{T}, the eigenvalues and eigenvectors are real. On the other hand, in the non-symmetric case A≠A^{T}, the eigenvalues and eigenvectors are complex. Plugging the decomposition A=PκP⁻¹ into Eq. (3) and multiplying both sides by P⁻¹, gives:

$${\overline{h}}_{i} = {\sum }_{k = 1}^{i} {Λ}^{k - 1} \overline{B} {x}_{i - k} , \qquad ( 4 )$$

where h̅ᵢ=P⁻¹hᵢ, and B̅=P⁻¹B. The linear recurrent layer 222 then computes an initial output as:

$${y}_{i} = Re [ \overline{C} {\overline{h}}_{i} ] + D {x}_{i - k} , \qquad ( 5 )$$

where C̅=C^{P-1}, and the linear recurrent layer 222 computes the real part (Re) of C̅h̅ᵢ. Therefore, instead of learning {A, B, C, D}, the linear recurrent layer 222 can equivalently learn the set of matrices {Λ, B̅, C̅, D}∈θ, where Λ, B̅, and C̅ are complex valued, and Λ is a diagonal transition matrix of eigenvalues. For ease of description, the hidden state, second matrix, and third matrix can be relabeled in canonical form as h̅ᵢ→hᵢ, B̅→B, and C̅→C, keeping in mind that these quantities are generally complex valued in the diagonalized parametrization of the linear recurrent layer 222. In some implementations, each eigenvalue of the diagonal transition matrix (Λ) has a magnitude less than one, which ensures stability of the linear recurrent layer 222. Particularly, the norm of component n of the hidden state at position i evolves as |h_{i,n}|=O(|λₙ|ⁱ). Therefore, a sufficient condition to ensure stability of the linear recurrent layer 222, e.g., such that hᵢ and its gradients do not explode, is that |λₙ|<1 for all n.

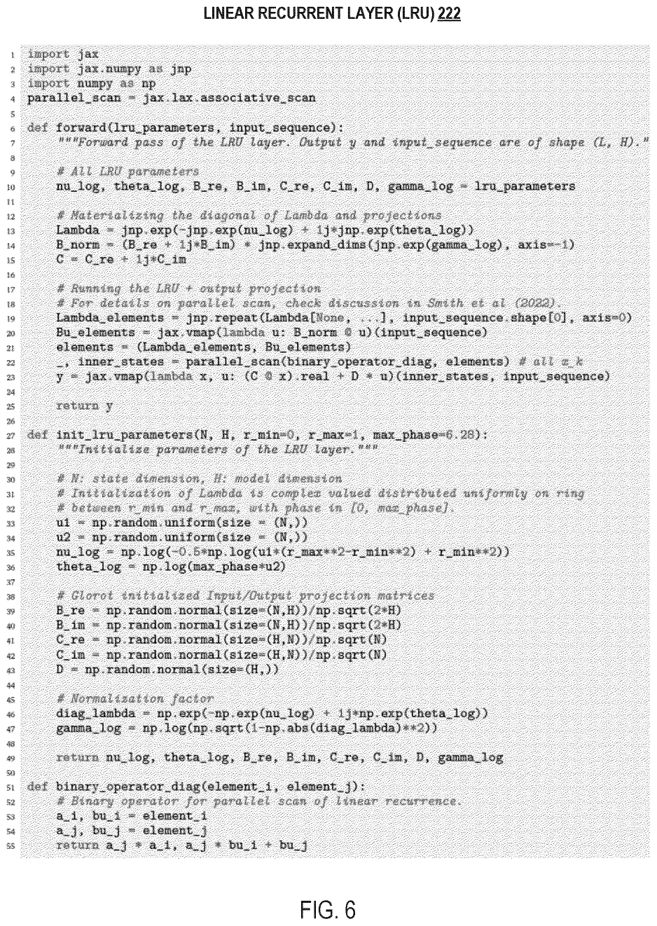

As a noteworthy application of the diagonalized parameterization, the linear recurrent layer 222 can compute the recurrence relations in Eqs. (4) and (5) in parallel, e.g., using parallel scans, to substantially speed up training and inference of the neural network 200. Particularly, since the transition matrix (Λ) is diagonal, the parallelization time is on the order of O(N log L) and involves O(NL) space. The linear recurrent layer 222 can implement parallel scans using a work-efficient algorithm (see FIG. 6 for example). Thus, for a diagonal transition matrix, the total computational cost of a parallel scan using L processors is on the order of O(NL). Further details related to work-efficient parallel (prefix) scans is provided Ladner, Richard E., and Michael J. Fischer. “Parallel prefix computation,” Journal of the ACM (JACM) 27.4 (1980): 831-838. In other implementations, the linear recurrent layer 222 can implement parallel scans using other algorithms that may offer more parallelism (but may not be work-efficient), such as the algorithm proposed by Hillis, W. Daniel, and Guy L. Steele Jr., “Data parallel algorithms,” Communications of the ACM 29.12 (1986): 1170-1183. Numerous different algorithms can be implemented by the linear recurrent layer 222 to compute a parallel scan as the design space grows exponentially with the sequence length as O(2^{L}^{²}). The general technique for constructing such an algorithm is described below:

To implement a parallel scan, e.g., a parallel prefix scan, the linear recurrent layer 222 can first precompute a respective input tuple cᵢ for each input position as:

$${c}_{i} = ( Λ , {Bx}_{i} ) , \qquad ( 6 )$$

with the initialization c₀=(I, 0), and I being the identity matrix. The linear recurrent layer 222 can then perform a prefix computation on the input tuples, which produces a respective hidden tuple sᵢ for each input position as:

$${s}_{i} = {c}_{i} ∘ {s}_{i - 1} = {c}_{i} ∘ {c}_{i - 1} ∘ … ∘ {c}_{0} , \qquad ( 7 )$$

where ∘ is a binary associative operator of the prefix computation. The associative operator (or prefix operator) implements the recurrence relation in Eq. (1), which performs an operation on any two operands cᵢ and cⱼ as:

$${c}_{i} ∘ {c}_{j} = ( Λ , {Bx}_{i} ) ∘ ( Λ , {Bx}_{j} ) = ( {Λ}^{2} , Λ B {x}_{i} + B {x}_{j} ) \qquad ( 8 )$$

Hence, the hidden tuple sᵢ=(Λⁱ, hᵢ) for each input position includes the updated hidden state hᵢ for the input position, which the linear recurrent layer 222 can then use to compute the initial output (yᵢ) for the position as in Eq. (5).

With the help of the prefix operator and Eq. (8), hidden tuples may be extended to groups of contiguous positions, from position j to position i (with i≥j), as follows:

$${s}_{i : j} = {c}_{i} ∘ {c}_{i - 1} ∘ … ∘ {c}_{j} . \qquad ( 9 )$$

Moreover, since the prefix operator is associative, the following relation also holds:

$${s}_{i : j} = {s}_{i : k} ∘ {s}_{k - 1 : j} \qquad ( 10 )$$

for i≥k>j. Eq. (10) implies that a contiguous group of positions can be decomposed into multiple contiguous subgroups. This allows the linear recurrent layer 222 to compute groups of hidden tuples (s_{i:j}) in parallel and then combine them to compute the hidden states as in Eq. (7), thus the term “parallel scan”, or “parallel prefix scan”.

For example, consider an input sequence 202 of length L=4. The linear recurrent layer 222 can compute the hidden tuples as: s₁=c₁∘c₀, s₂=c₂∘s₁, s₃=c₃∘s₂, and s₄=s_{4:3}∘s₂, with s_{4:3}=c₃∘c₂. Introducing the additional term s_{4:3} breaks the dependency of s₄ on s₃, allowing the linear recurrent layer 222 to compute the two in parallel. This parallelization can significantly reduce the number of sequential steps the linear recurrent layer 222 performs when the sequence length is large, since the parallel time scales logarithmically with the sequence length. Furthermore, it is suitable for implementation in parallel by multiple (L) processors, e.g., multiple cores of an integrated circuit.

This procedure can also be used by the training engine 500 to efficiently compute gradients of the hidden states in parallel during training. For example, consider the derivative of s_{i:j} with respect to an eigenvalue of the diagonal transition matrix:

$$\frac{\partial {s}_{i : j}}{\partial {λ}_{n}} = \frac{\partial {s}_{i : k}}{\partial {λ}_{n}} ∘ {s}_{k - 1 : j} + {s}_{i : k} ∘ \frac{\partial {s}_{k - 1 : j}}{\partial {λ}_{n}} , \qquad ( 11 )$$

for i≥k>j. Eq. (11) implies that a gradient for a contiguous group of positions can be decomposed into gradients of its contiguous subgroups. This allows the training engine 500 to compute gradients of hidden tuples (s_{i:j}) in parallel and then combine them.

Returning to the example above, with an input sequence 202 of length L=4. The training engine 500 can compute the gradients of the hidden tuples as:

$$\frac{\partial {s}_{1}}{\partial {λ}_{n}} = \frac{\partial {c}_{1}}{\partial {λ}_{n}} ∘ {c}_{0} , \frac{\partial {s}_{2}}{\partial {λ}_{n}} = \frac{\partial {c}_{2}}{\partial {λ}_{n}} ∘ {s}_{1} + {c}_{2} ∘ \frac{\partial {s}_{1}}{\partial {λ}_{n}} , \qquad ( 12 a )$$

and,

$$\frac{\partial {s}_{3}}{\partial {λ}_{n}} = \frac{\partial {c}_{3}}{\partial {λ}_{n}} ∘ {s}_{2} + {c}_{3} ∘ \frac{\partial {s}_{2}}{\partial {λ}_{n}} , \frac{\partial {s}_{4}}{\partial {λ}_{n}} = \frac{\partial {s}_{4 : 3}}{\partial {λ}_{n}} ∘ {s}_{2} + {s}_{4 : 3} ∘ \frac{\partial {s}_{2}}{\partial {λ}_{n}} . \qquad ( 12 b )$$

Again, introducing the additional term s_{4:3} breaks the dependency of s₄ on s₃, allowing the training engine 500 to compute the gradients of each in parallel.

The diagonalized re-parametrization described above generally reduces the overall number of parameters of the linear recurrent layer 222, without limiting expressivity, as well as providing computational speedups for both training and inference of the neural network 200. The reasons for this are due, at least in part, to: (i) computing powers of diagonal matrices is computationally cheap (speeding up both training and inference), and (ii) unrolling a linear recurrence can be parallelized using associative scans resulting in faster training and inference. Tbl. 2 shows that a diagonal transition matrix improves inference accuracy of the neural network 200 on tasks like ListOps and sCIFAR, while also reducing training and inference time on all LRA tasks. It is particularly suitable for implementation in a parallel computing system.

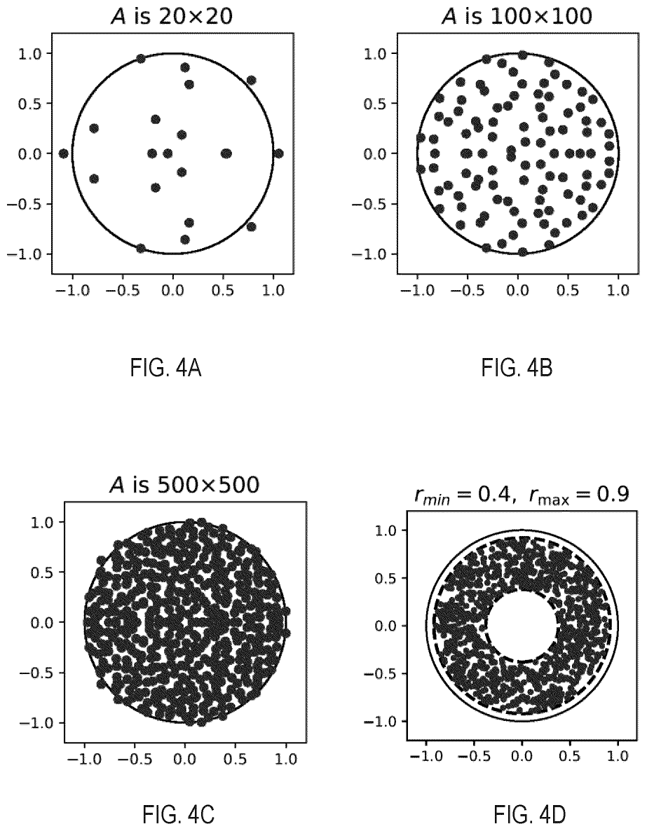

Referring to FIGS. 4A-4D, the training engine 500 can randomly initialize the transition matrix of the linear recurrent layer 222 in a manner that is stable. FIGS. 4A-4C show examples of eigenvalues of the (non-diagonal) transition matrix A∈ [symbol] ^{N×N} following a Glorot initialization for 20×20, 100×100, and 500×500 sized matrices, respectively. Each entry of A was sampled independently from a Gaussian distribution with a mean of 0 and variance of 1/N. The eigenvalues are complex (A is not symmetric) and are represented on the complex plane. The black circle is the unit disk {|z|=1}⊆ [symbol] FIG. 4D shows eigenvalues of the diagonal transition matrix (Λ) following an “equivalent spectral initialization” (or ESI). Under a Glorot initialization, the spectrum of the transition matrix A is, at least approximately, sampled from the unit disk in [symbol] . The ESI follows analogously for the diagonal transition matrix Λ. Using the exponential of a complex argument exp(−v+iθ), the training engine 500 can sample uniformly on a ring between circles with radii rₘᵢₙ and rₘₐₓ in [symbol] . Particularly, for the linear recurrent layer 222 to learn long-range dependencies and avoid vanishing gradients, the training engine 500 can initialize the eigenvalues of the diagonal transition matrix close to 1 by choosing suitable values for rₘᵢₙ and rₘₐₓ, e.g., such that rₘᵢₙ=0.9 and rₘₐₓ=0.999, or rₘᵢₙ=0.999 and rₘₐₓ=0.9999, etc.

The ESI also suggests a parameterization of the linear recurrent layer 222 in terms of the exponential of a complex argument:

$$Λ = diag ( exp ( - ν + i θ ) ) , \qquad ( 13 )$$

with v∈ [symbol] ^{N} and θ∈ [symbol] ^{N} as the learnable parameters (instead of the real and imaginary parts of Λ). For instance, this choice of “exponential parameterization” decouples magnitude and oscillation frequencies, thereby stabilizing optimization with stochastic gradient descent methods.

Another benefit of the exponential parameterization is that the linear recurrent layer 222 can enforce stability on the eigenvalues, e.g., proceeding initialization, by restricting the domain of the learnable parameter v. To see this, consider the initialization |λₙ|=|exp(−vₙ)|<1 with vₙ>0. Therefore, to preserve stability during training, the linear recurrent layer 222 can use an exponential or another positive nonlinearity to parameterize the diagonal transition matrix:

$$Λ = diag ( exp ( - exp ( {ν}^{log} ) + i θ ) ) , \qquad ( 14 )$$

where v^{log}∈ [symbol] ^{N} is the vector of log eigenvalue magnitudes and θ∈ [symbol] ^{N} is the vector of eigenvalue phases, corresponding to the learnable parameters. For example, the exponential non-linearity achieves |λₙ|=1 at v^{log}=−∞, and |λₙ|=0 at v^{log}=∞. This “stable exponential parameterization” generally helps for training the linear recurrent layer 222 on long-range tasks. Moreover, to reduce the oscillations in the eigenvalues during training, the linear recurrent layer 222 can also re-parameterize the eigenvalue phases logarithmically as θ=exp(θ^{log}), with θ^{log}∈ [symbol] ^{N} being the learnable parameter for the phase. The training engine 500 can then initialize the phase of an eigenvalue to a thin slice near 0, e.g., in a range from [0, π/10], a range from [0, π/50], a range from [0, π/100], etc.

Table 2: Inference accuracy of the neural network 200 using linear recurrent layers 222 with diagonal transition matrices, under different parameterizations of the diagonal transition matrices. Results are shown from sCIFAR, ListOps, and Pathfinder tasks in the Long-Range Arena (LRA). Bold face indicates the parameterization option with the best inference accuracy.

TABLE 2
Inference accuracy of the neural network 200 using linear
recurrent layers 222 with diagonal transition matrices,
under different parameterizations of the diagonal transition
matrices. Results are shown from sCIFAR, ListOps, and
Pathfinder tasks in the Long-Rande Arena (LRA).

| Parametrization | sCIFAR | ListOps | Pathfinder |
|---|---|---|---|
| Dense A | 72.2 (0.2) | 50.4 (0.2) | — |
| Λ Real + Im | 86.5 (0.1) | 58.8 (0.3) | — |
| Λ Exp | 85.4 (0.7) | 60.5 (0.3) | 65.4 (9.0) |
| Λ Stable Exp | 87.2 (0.4) | 59.4 (0.3) | 93.5 (0.5) |
| +Ring Init. | 88.1 (0.0) | 59.4 (0.3) | 94.4 (0.3) |

Bold face indicates the parameterization option with the best inference accuracy.

Lastly, for additional stability during training, e.g., to stabilize the training loss, the linear current layer 222 can be further parameterized by a normalization parameter γ∈ [symbol] ^{N}, that is initialized element-wise by the training engine 500 as γₙ←\sqrt{1−|λₙ|²}. The recurrence relation of Eq. (1) is then normalized (in diagonal form) as:

$${h}_{i} = Λ {h}_{i - 1} + γ ⊙ ( {Bx}_{i} ) , \qquad ( 15 )$$

where ⊙ denotes the element-wise product. The normalization parameter allows the linear recurrent layer 222 to adaptively scale the input xᵢ fed into the corresponding eigendirection. In a similar vein as above, to improve stability, the linear recurrent layer 222 can also re-parameterize the normalization parameter logarithmically as γ=exp(γ^{log}), with γ^{log}∈ [symbol] ^{N} being the argument for the normalization parameter. In this case, the training engine 500 initializes the argument for the normalization parameter element-wise by as

$${γ}_{n}^{log} ← log ( \sqrt{1 - {\vert {λ}_{n} \vert}^{2}} ) .$$

The γ normalization can improve performance on tasks that benefit from initializing close to the unit disk, such as sCIFAR and Pathfinder.

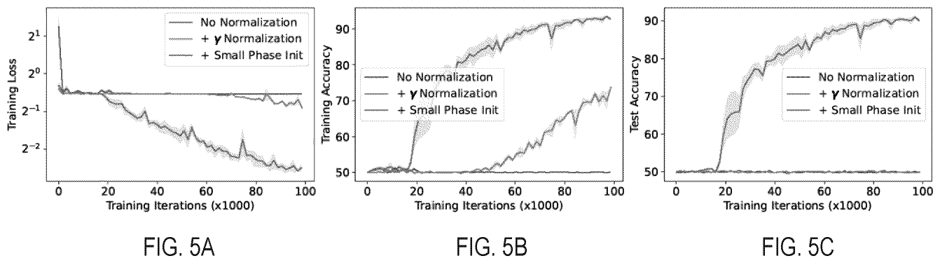

FIGS. 5A-5C show the effect of the normalization parameter and using a small phase at initialization on the PathX task. FIG. 5A is a plot showing training loss versus training iterations of the neural network 200. FIG. 5B is a plot showing training accuracy versus training iterations of the neural network 200. FIG. 5C is a plot showing test accuracy versus training iterations of the neural network 200. Each of FIGS. 5A-5C shows mean and standard errors over three independent runs for 100k training iterations. Without normalization, the neural network 200 presents higher loss values at initialization and quickly converges to a suboptimal value, where training and test accuracy are both at random chance. Adding the normalization parameter helps. The training loss is lower at initialization, and the AdamW optimizer is able to escape the suboptimal region. Training accuracy also increases. Finally, reducing the initialization phase (i.e., tuning the range of θ) improves convergence on the training dataset, while also generalizing to the test dataset.

FIG. 3B is a flow diagram of an example process 600 for training the neural network 200 to perform a machine learning task. For convenience, the process 600 will be described as being performed by a system of one or more computers located in one or more locations. For example, a training engine, e.g., the training engine 500 of FIG. 3A, appropriately programmed in accordance with this specification, can perform the process 600.

The training engine initializes the network parameters (θ) of the neural network 200, including the respective parameters of one or more of the linear recurrent layers 222 (610).

For example, when the first (transition) matrices (A) of the linear recurrent layers 222 are parametrized in diagonal form, e.g., as in Eq. (4), the training engine can initialize the eigenvalues (λₙ) of the diagonal transition matrices (Λ) on a ring, between rₘᵢₙ and rₘₐₓ, using the equivalent spectral initialization (ESI). In these cases, the diagonal transition matrices may be parameterized according to the exponential parameterization, e.g., as in Eq. (13), or the stable exponential parameterization, e.g., as in Eq. (14). The training engine can initialize the eigenvalues of the diagonal transition matrices close to 1 by choosing suitable values for rₘᵢₙ and rₘₐₓ. The training engine can also initialize the phases of the eigenvalues to a thin slice near 0. Moreover, when the linear recurrent layers 222 are further parametrized by normalization parameters γ^{log}, e.g., as in Eq. (15), the training engine can initialize the normalization parameters element-wise as

$${γ}_{n}^{log} ← log ( \sqrt{1 - {\vert {λ}_{n} \vert}^{2}} ) .$$

The training engine can initialize the second (B), third (C), and fourth (D) matrices of the linear recurrent layers 222 using various initialization schemes. For example, the training engine can initialize the second (B) and third (C) matrices of the linear recurrent layers 222 using a Glorot initialization. The training engine can initialize the fourth (D) matrices of the linear recurrent layers 222 using a random initialization.

The training engine obtains a training dataset 510 related to the machine learning task (620). The training dataset 510 includes multiple training examples 512 that each include: (i) a respective training network input 502, and (ii) a corresponding target network output 503.

The training engine processes the training network input 502 of each training example 512, using the neural network 200, to generate a training network output 504 that is an estimate of the corresponding target network output 503 for the training example 512 (630).

The training engine determines gradients 530 of an objective function 540 that depends on the training 504 and target 503 network outputs of each training example 512 (640).

For example, the training engine use backpropagation to determine the gradients 530 of the objective function 540 with respect to the network parameters of the neural network 200.

The training engine uses the gradients 530 of the objective function 520 to update the network parameters of the neural network 200, including the respective parameters of one or more of the linear recurrent layers 222 (650).

For example, the training engine can use a stochastic gradient descent method with a particular learning rate and/or weight decay, e.g., Implicit updates, Momentum, Adam, RMSProp, AdaGrad, among others, to update the network parameters with the values that optimize the objective function 520.

FIG. 6 shows an example JAX implementation of a linear recurrent layer 222, aka the “Linear Recurrent Unit” (or LRU). See J. Bradbury, et al., “JAX: Composable Transformations of Python+Numpy Programs” (2018) for details regarding JAX code. The hidden state (hᵢ) of the linear recurrent unit 222 is driven by the input

$${( {x}_{i} )}_{i = 1}^{L}$$

of sequence length L according to the following formula (and parallelized using an associative scan): hᵢ=Λhᵢ₋₁+exp(γ^{log})⊙(Bxᵢ). The (initial) output is computed at each input position i as follows: yᵢ=Chᵢ+Dxᵢ. In the JAX code, B and C follow Glorot initialization, with B scaled additionally by a factor 2, to account for halving the state variance, by taking the real part of the output projection. D is random and multiplies element-wise each xᵢ, at the i-th position. Λ is initialized according to the equivalent spectral initialization (ESI), with phase (potentially) restricted to a thin slice.

To conclude, examples of machine learning tasks that the system 100 can perform using the neural network 200 are described in the following.

As one example, the machine learning task can be a neural machine translation task. For example, if the network input 102 to the neural network 200 is a sequence of text, e.g., a sequence of words, phrases, characters, or word pieces in one (e.g., natural) language, the network output 104 generated by the neural network 200 may be a translation of the sequence of text into another (e.g., natural) language, i.e., a sequence of text in the other language that is a translation of the input sequence of text. As a particular example, the machine learning task can be a multi-lingual machine translation task, where the neural network 200 is configured to translate between multiple different source language-target language pairs. In this example, the source language text may be augmented with an identifier that indicates the target language into which the neural network 200 should translate the source language text.

As another example, the machine learning task can be an audio processing task. For example, if the network input 102 to the neural network 200 is a sequence representing a spoken utterance, the network output 104 generated by the neural network 200 may be a score for each of a set of pieces of text, each score representing an estimated likelihood that the piece of text is the correct transcript for the utterance. As another example, if the network input 102 to the neural network 200 is a sequence, e.g., data recorded by a microphone, representing a spoken utterance, the network output 104 generated by the neural network 200 can indicate whether a particular word or phrase (“hotword”) was spoken in the utterance. As another example, if the network input 102 to the neural network 200 is a sequence representing a spoken utterance, the network output 104 generated by the neural network 200 can identify the natural language in which the utterance was spoken.

As another example, the machine learning task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the machine learning task can be a text-to-speech task, where the network input 102 is text in a natural language (e.g., a sequence of tokens as described above), or features of text in a natural language, and the network output 104 is a spectrogram, a waveform, or other data defining audio of the text being spoken in the natural language.

As another example, the machine learning task can be a health prediction task, where the network input 102 is a sequence derived from electronic health record data for a patient and the network output 104 is a prediction that is relevant to the future health of the patient, e.g., a predicted treatment that should be prescribed to the patient, the likelihood that an adverse health event will occur to the patient, or a predicted diagnosis for the patient.

As another example, the machine learning task can be a text generation task, where the network input 102 is a sequence of text, and the network output 104 is another sequence of text, e.g., a completion of the input sequence of text, a response to a question posed in the input sequence, or a sequence of text that is about a topic specified by the first sequence of text. As another example, the network input 102 for the text generation task can be an input other than text, e.g., an image, and the network output 104 can be text that describes the network input 102.

As another example, the machine learning task can be an image generation task, where the network input 102 is a conditioning input, e.g., text, a lower-resolution image, or a partial image, and the network output 104 is a sequence of intensity values of the pixels of an image.

As another example, the machine learning task can be an image processing task. For example, the network input 102 can be the intensity values of the pixels of an image (or an encoded representation of the intensity values generated by an encoder neural network), and the network output 104 can be: (i) an image classification output that classifies the image into one of a number of object categories, (ii) an object detection output, i.e., a sequence that specifies the coordinates of one or more bounding boxes in the image that are predicted to encompass objects, or (iii) a segmentation output that classifies each pixel in the image into one of a number of categories.

As another example, the machine learning task can be an agent control task, where the network input 102 is a sequence of observations or other data characterizing states of an environment, and the network output 104 defines an action to be performed by the agent in response to the most recent data in the sequence. The agent can be, e.g., a real-world or simulated robot, a control system for an industrial facility, or a control system that controls a different kind of agent.

As another example, the machine learning task can be a genomics task, where the network input 102 is a sequence representing a fragment of a DNA sequence or other molecule sequence and the network output 104 is either an embedding of the fragment for use in a downstream task, e.g., by making use of an unsupervised learning technique on a data set of DNA sequence fragments, or an output for the downstream task. Examples of downstream tasks include, but are not limited to, promoter site prediction, methylation analysis, predicting functional effects of non-coding variants, and so on.

In some cases, the machine learning task is a combination of multiple individual machine learning tasks, i.e., the system 100 is configured to perform multiple different individual machine learning tasks, e.g., two or more of the machine learning tasks mentioned above. For example, the system 100 can be configured to perform multiple individual natural language understanding tasks, with the network input 102 including an identifier for the individual natural language understanding task to be performed on the network input 102.

The system 100 can use the neural network 200 to generate a network output 104 that includes an output sequence in response to a network input 102 that includes an input sequence. Examples of sequence-to-sequence machine learning tasks that can be performed by the system 100 are described in the following.

In some implementations, either or both of the network input 102 and network output 104 may each include a sequence of tokens. That is, the network input 102 can include a sequence of input tokens and the network output 104 can include a sequence of output tokens.

For example, in some cases, the input and output tokens each represent words, wordpieces, or characters in a natural language. A wordpiece may be a sub-word (part of a word) and may be an individual letter or character. As used here, “characters” includes Chinese and other similar characters, as well as logograms, syllabograms and the like.

Some of these implementations of the system 100 may be used for natural language tasks such as providing a natural language response to a natural language input, e.g., for question answering, or for text completion. In some implementations, the network input 102 may represent text in a natural language and the network output 104 may represent text in the same natural language, e.g., a longer item of text. For example, the network input 102 may represent text in a natural language and the network output 104 may represent the same text with a missing portion of the text added or filled in. For example, the network output 104 may represent a predicted completion of text represented by the network input 102. Such an application may be used, e.g., to provide an auto-completion function, e.g., for natural language-based search. In some implementations, the network input 102 may represent text in a natural language, e.g., posing a question or defining a topic, and the network output 104 may represent text in the same or different natural language which is a response to the question or about the specified topic.

As another example, the network input 102 may represent a first item of text and the network output 104 may represent a second, shorter item of text, e.g., the second item of text may be a summary of a passage that is the first item of text. As another example, the network input 102 may represent a first item of text and the network output 104 may represent a simplification of the first item of text. As another example, the network input 102 may represent a first item of text and the network output 104 may represent an aspect of the first item of text. For example, the network output 104 may represent results of an entailment task, a paraphrase task, a textual similarity task, a sentiment analysis task, a sentence completion task, a grammaticality task, a parsing task, e.g., constituency parsing, or any natural language understanding task that operates on a sequence of text in some natural language, e.g., to generate an output that classifies or predicts some property of the text. For example, some implementations of the system 100 may be used to identify a natural language of the first item of text (or of spoken words when the input sequence is audio, as described below).

Some implementations of the system 100 may be used to for neural machine translation. In such applications, the input tokens may represent words, wordpieces, or characters in a first natural language and the output tokens may represent words, wordpieces, or characters in a second, different natural language. That is, the network input 102 may represent input text in the first language and the network output 104 may represent a translation of the input text into the second language.

Some implementations of the system 100 may be used for automatic code generation. In such applications, the input tokens may represent words, wordpieces, or characters in a first natural language and the output tokens may represent instructions in a computer programming or markup language, or instructions for controlling an application program to perform a task, e.g., build a data item such as an image or web page.

Some implementations of the system 100 may be used for speech recognition. In such applications, the network input 102 may represent spoken words and the network output 104 may represent a conversion of the spoken words to a machine-written representation, e.g., text. Then, the input tokens may include tokens representing an audio data input including the spoken words, e.g., characterizing a waveform of the audio in the time domain or in the time-frequency domain. The output tokens may represent words, wordpieces, characters, or graphemes of a machine-written (e.g., text) representation of the spoken input, that is representing a transcription of the spoken input.

Some implementations of the system 100 may be used for handwriting recognition. In such applications, the network input 102 may represent handwritten words, syllabograms, or characters and the network output 104 may represent a conversion of the network input 102 to a machine-written representation, e.g., text. Then, the input tokens may include tokens representing portions of the handwriting and the output tokens may represent words, wordpieces, characters, or graphemes of a machine-written (e.g., text) representation of the spoken input.

Some implementations of the system 100 may be used for text-to-speech conversion. In such applications, the network input 102 may represent text and the network output 104 may represent a conversion of the text to spoken words. Then the input tokens may include tokens representing words, wordpieces, or graphemes of the text and the output tokens may represent portions of audio data for generating speech corresponding to the text, e.g., tokens characterizing a portion of a waveform of the speech in the time domain or in the time-frequency domain, or phonemes.

In some implementations, the network input 102 and network output 104 may each include sequences of tokens that represent different modalities of input and/or output. For example, the network input 102 may represent text in a natural language and the network output 104 may represent an image or video corresponding to the text; or vice-versa. In general, the tokens may represent image or video features and a sequence of such tokens may represent an image or video. There are many ways to represent an image (or video) using tokens. As one example, an image (or video) may be represented as a sequence of regions of interest (RoIs) in the image (or video), optionally including one or more tokens for global image features. For example, an image may be encoded using an encoder neural network to extract Rol features; optionally (but not essentially) a token may also include data, e.g., a position encoding, representing a position of the Rol in the image. As another example, the tokens may encode color or intensity values for pixels of an image. As another example, some image processing neural network systems, e.g., autoregressive systems, naturally represent images as sequences of image features.

In some implementations, at least one of the network input 102 or network output 104 is a sequence representing an image or video, and the tokens represent the image or video. For example, the network input 102 may be a sequence of text, the input tokens may represent words, wordpieces, or characters, and the network output 104 may include output tokens representing an image or video, e.g., described by the text, or providing a visual answer to a question posed by the text, or providing a visualization of a topic of the text. In another example, the network input 102 may include a sequence of input tokens representing an image or video, e.g., captured from the real world using a camera, and the output tokens may represent words, wordpieces, or characters of text, e.g., as a description or characterization of the image or video, or by providing an answer to a question posed visually by the image or video, or by providing information on a topic in the image or video.

In other implementations, both the network input 102 and the network output 104 may represent an image or video, and both the input and output tokens may represent a respective image or video. In such implementations, the system 100 may be configured to perform an image or video transformation. For example, the network input 102 and network output 104 may represent the same image or video in different styles, e.g., one as an image and the other as a sketch of the image; or different styles for the same item of clothing.

In some implementations, the network input 102 represents data to be compressed, e.g., image data, text data, audio data, or any other type of data; and the network output 104 is a compressed version of the data. The input and output tokens may each include any representation of the data to be compressed/decompressed, e.g., symbols or embeddings generated/decoded by a respective neural network.

In some implementations, the network input 102 represents a sequence of actions to be performed by an agent, e.g., a mechanical agent in a real-world environment implementing the actions to perform a mechanical task. The network output 104 may include a modified sequence of actions, e.g., one in which an operating parameter, such as a speed of motion or power consumption, has a limited value; or one in which a safety or other boundary is less likely to be crossed. Then, both the input and output tokens may represent the actions to be performed.

In some implementations, the network input 102 represents a sequence of health data, and the network output 104 may include a sequence of predicted treatment. Then the input tokens may represent any aspect of the health of a patient, e.g., data from blood and other medical tests on the patient and/or other patient data; and the output tokens may represent diagnostic information, e.g., relating to a disease status of the patient and/or relating to suggested treatments for the patient, and/or relating to a likelihood of an adverse health event for the patient.

In some implementations, the network input 102 represents a time series, and the output sequence may include a continuation of the time series. For example, the network input 102 may be a sequence representing the output of an electricity generating plant, e.g., a solar or wind electricity generating plant, or a sequence representing electricity consumption, and the network output 104 may provide a forecast of the electricity generated or consumed. As another example, the network input 102 may be a sequence representing a level of traffic on one or more roads and the network output 104 may provide a forecast of the future traffic.

The system 100 can use the neural network 200 to process and/or perform machine learning tasks on various types of data. Examples of different types of data that can be processed by the neural network 200 are described in the following.

In implementations when the network input 102 includes a sequence of inputs, each input in the network input 102 may be a data element embedding. As used herein, an embedding refers to an ordered collection of numerical values, e.g., a vector, matrix, or other tensor of numerical values.

For example, the data element embeddings may represent the pixels of an image and the network output 104 may include a classification output, e.g., which includes a respective score for each object category in a set of possible object categories, defining a likelihood that the image depicts an object that belongs to the object category.

In some implementations, the data element embeddings represent audio samples in an audio waveform and the system 100 is configured to perform speech recognition, i.e., to generate a network output 104 that defines a sequence of phonemes, graphemes, characters, or words corresponding to the audio waveform.

In some implementations, the data element embeddings represent words in a sequence of words and the system 100 is configured to perform a natural language processing task, e.g., topic classification or summarization. To perform topic classification, the network output 104 can include a respective score for each topic category in a set of possible category categories, e.g., the score for a topic category can define a likelihood that the sequence of words pertains to the topic category.

In some implementations, the system 100 is configured to perform an audio processing task. For example, if the data element embeddings represent a spoken utterance, then the network output 104 may be a score for each of a set of pieces of text, each score representing an estimated likelihood that the piece of text is the correct transcript for the utterance. As another example, if the data element embeddings represent a spoken utterance, the network output 104 can indicate whether a particular word or phrase (“hotword”) was spoken in the utterance. As another example, if the data element embeddings represent a spoken utterance, the network output 104 can identify the natural language in which the utterance was spoken.

In some implementations, the system 100 can perform an image generation task, where the data element embeddings represent a conditioning input, e.g., text, and the network output 104 defines a sequence of intensity value inputs for the pixels of an image.

In some implementations, as described further below, the system 100 can perform an agent control task, where the data element embeddings represent a sequence of one or more observations and/or other data characterizing states of an environment, and the network output 104 includes a policy output. The agent can be, e.g., a real-world or simulated mechanical agent (such as a robot or vehicle), a control system for an industrial facility, or a control system that controls a different kind of agent.

In some implementations, the system 100 can perform a point cloud processing task, e.g., where the data element embeddings represent a point cloud (e.g., generated by a lidar or radar sensor) and the network output 104 characterizes, e.g., a type of object represented by the point cloud.

In some implementations, the system 100 is configured to perform a combination of multiple individual machine learning tasks, e.g., two or more of the machine learning tasks mentioned above.

The neural network 200 can process data element embeddings that represent any appropriate type of entity. For example, the entity can include an image, an audio waveform, a point cloud (e.g., generated by a lidar or radar sensor), a protein, a sequence of words (e.g., that form one or more sentences or paragraphs), a video (e.g., represented a sequence of video frames), or a combination thereof, e.g., multimodal data. The network output 104 can characterize the entity or performs a processing task on the entity.

Implementations of the system 100 can process multimodal data of a multimodal entity. Such an entity can include a combination of different types of data, such as image or video data and audio data, image or video data and language data, somatosensory input data (sensor data sensing the real-world environment of a physical agent, such as sensing touch, pressure, movement, temperature or vibration data) and motor feedback data (i.e., control data to control movement of the physical agent). When a multimodal entity is processed by the system 100, embeddings of the data elements of the different modalities may be combined.

The network output 104 for the multimodal entity may be as previously described. For example, when the network output 104 is a classification output for a classification task (e.g., defining a score for each category of a set of possible categories), this may be as previously described except that the network output 104 is generated based upon the multimodal data embeddings provided as the network input 102. Thus, the machine learning task, e.g., a classification task, performed by the system 100 may be performed better, e.g., more accurately, as a result. For example, a classification task may be performed on a combination of video and (corresponding) audio data to obtain a more accurate classification result. As another example, the machine learning task may be one that is based upon processing data of different modalities, e.g., in a task that combines video or image data and language data, e.g., text data, to determine whether an image or video is described by a particular caption.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A system for performing a machine learning task on a network input to generate a network output, the system comprising one or more computers and one or more storage devices storing instructions that, when executed by the one or more computers, cause the one or more computers to implement:
a neural network configured to perform the machine learning task, the neural network comprising a plurality of layer blocks each comprising: (i) a linear recurrent layer, and (ii) one or more feedforward layers,
wherein each layer block is configured to perform operations comprising:
receiving an input sequence for the layer block that comprises a respective input at each of a plurality of input positions; and
generating an output sequence for the layer block that comprises a respective output at each of a plurality of output positions, the generating comprising:
processing the input sequence, using the linear recurrent layer of the layer block, to generate an initial output sequence that comprises a respective initial output at each of the plurality of input positions; and
processing the initial output sequence, using the one or more feedforward layers of the layer block, to generate the output sequence.

2. The system of claim 1, wherein:
the plurality of layer blocks are organized in a sequence, and
for each layer block that is not a first layer block in the sequence of layer blocks, the input sequence for the layer block is the output sequence of a preceding layer block in the sequence of layer blocks.

3. The system of claim 2, wherein the network input is the input sequence for the first layer block in the sequence of layer blocks.

4. The system of claim 2, wherein the neural network further comprises an encoder configured to perform operations comprising:
receiving the network input; and
processing the network input to generate the input sequence for the first layer block in the sequence of layer blocks.

5. The system of claim 4, wherein the encoder is a linear encoder.

6. The system of claim 2, wherein the neural network further comprises one or more output layers configured to perform operations comprising:
receiving the output sequence of a last layer block in the sequence of layer blocks; and
processing the output sequence of the last layer block to generate the network output.

7. The system of claim 6, wherein the one or more output layers are linear layers.

8. The system of claim 1, wherein the linear recurrent layer of each layer block is parametrized by a plurality of matrices, and wherein processing the input sequence, using the linear recurrent layer of the layer block, to generate the initial output sequence comprises, for each input position:
obtaining a current hidden state;
computing a first matrix-vector product between: (i) a first matrix of the linear recurrent layer, and (ii) the current hidden state;
receiving the input for the input position;
computing a second matrix-vector product between: (i) a second matrix of the linear recurrent layer, and (ii) the input for the input position; and
summing the first and second matrix-vector products to generate an updated hidden state.

9. The system of claim 8, wherein the first matrix of each linear recurrent layer is a diagonal matrix parametrized by a plurality of eigenvalues.

10. The system of claim 9, wherein each eigenvalue has a magnitude less than one.

11. The system of claim 9, wherein the eigenvalues include complex eigenvalues.

12. The system of claim 11, wherein each complex eigenvalue is represented as an exponential function parametrized by a complex argument.

13. The system of claim 8, wherein the linear recurrent layer of each layer block is further parametrized by a normalization parameter, and wherein processing the input sequence, using the linear recurrent layer of the layer block, to generate the initial output sequence further comprises, for each input position:
computing an element-wise product between: (i) the normalization parameter of the linear recurrent layer, and (ii) the second matrix-vector product, and
wherein summing the first and second matrix-vector products to generate the updated hidden state comprises:
summing the first matrix-vector product and the element-wise product to generate the updated hidden state.

14. The system of claim 8, wherein processing the input sequence, using the linear recurrent layer of the layer block, to generate the initial output sequence further comprises, for each input position:
computing a third matrix-vector product between: (i) a third matrix of the linear recurrent layer, and (ii) the updated hidden state;
computing a fourth matrix-vector product between: (i) a fourth matrix of the linear recurrent layer, and (ii) the input for the input position; and
summing the third and fourth matrix-vector products to generate the initial output for the input position.

15. The system of claim 8, wherein the neural network has been trained on a plurality of training examples to perform the machine learning task, each training example comprising: (i) a respective training network input, and (ii) a corresponding target network output, and wherein the training comprised:
processing the training network input of each training example, using the neural network, to generate a training network output that is an estimate of the corresponding target network output for the training example;
determining gradients of an objective function that depends on the training and target network outputs of each training example; and
using the gradients of the objective function to update the respective parameters of one or more of the linear recurrent layers.

16. The system of claim 15, wherein the training further comprised, for each linear recurrent layer that was updated:
initializing the complex argument of each complex eigenvalue parametrizing the linear recurrent layer near zero.

17. The system of claim 15, wherein the training further comprised, for each linear recurrent layer that was updated:
initializing the normalization parameter parametrizing the linear recurrent layer using the eigenvalues of the first matrix of the linear recurrent layer.

18. The system of claim 1, wherein for each layer block, the number of input positions for the layer block is equal to the number of output positions for the layer block.

19. The system of claim 1, wherein the one or more feedforward layers of each layer block comprise: (i) a multilayer perceptron, (ii) a gated linear unit, or (iii) both.

20-30. (canceled)

31. One or more computer storage media storing instructions that, when executed by one or more computers, cause the one or more computers to implement:
a neural network configured to perform a machine learning task, the neural network comprising a plurality of layer blocks each comprising: (i) a linear recurrent layer, and (ii) one or more feedforward layers,
wherein each layer block is configured to perform operations comprising:
receiving an input sequence for the layer block that comprises a respective input at each of a plurality of input positions; and
generating an output sequence for the layer block that comprises a respective output at each of a plurality of output positions, the generating comprising:
processing the input sequence, using the linear recurrent layer of the layer block, to generate an initial output sequence that comprises a respective initial output at each of the plurality of input positions; and
processing the initial output sequence, using the one or more feedforward layers of the layer block, to generate the output sequence.

32. A method performed by one or more computers, the method comprising:
receiving a network input; and
processing the network input using a neural network to generate a network output for the network input, the neural network comprising a plurality of layer blocks each comprising: (i) a linear recurrent layer, and (ii) one or more feedforward layers,
wherein each layer block is configured to perform operations comprising:
receiving an input sequence for the layer block that comprises a respective input at each of a plurality of input positions; and
generating an output sequence for the layer block that comprises a respective output at each of a plurality of output positions, the generating comprising:
processing the input sequence, using the linear recurrent layer of the layer block, to generate an initial output sequence that comprises a respective initial output at each of the plurality of input positions; and
processing the initial output sequence, using the one or more feedforward layers of the layer block, to generate the output sequence.
